(19) United States
(12) Patent Application Publication
(10) Pub. No.: US 2018/0290102 A1
(43) Pub. Date: Oct. 11, 2018

(54) METHOD FOR SEPARATING WATER FROM A GASEOUS WORKING MEDIUM, AND WATER SEPARATOR FOR A WORKING MEDIUM

(71) Applicant: LINDE AKTIENGESELLSCHAFT, München (DE)

(72) Inventors: Robert Adler, Gerasdorf (AT); Ekkehardt Klein, Katzelsdorf (AT); Markus Rasch, Sulz im Wienerwald (AT); Christoph Nagl, Alland (AT); Andreas Pollak, Wien (AT)

(21) Appl. No.: 15/531,555

(22) PCT Filed: Dec. 1, 2015
(86) PCT No.: PCT/EP2015/002413

§ 371 Date: May 30, 2017

(30) Foreign Application Priority Data
Dec. 4, 2014 (DE) 10 2014 017 966.4

(51) Int. Cl. B01D 53/26; B01D 53/14; B01D 53/18; B01D 53/28; B01D 46/00; C10L 3/10; C01B 3/50

(52) U.S. Cl. CPC B01D 53/263; C01B 2203/0415; B01D 53/1425; B01D 53/1493; B01D 53/18; B01D 53/28; B01D 46/0036; B01D 46/0031; C10L 3/106; C01B 3/50; B01D 2252/30; C10L 2290/06; C10L 2290/08; C10L 2290/547; C10L 2290/60; C01B 2203/0495; C10L 2290/541; B01D 53/1412

(57) ABSTRACT

The invention relates to a method for separating water from a gaseous working medium (2), at least the following steps being carried out: providing an ionic hygroscopic liquid (4) in a reaction chamber (3); supplying the water-containing working medium (2) and conducting the working medium (2) through the ionic liquid (4), wherein water bonds with the ionic liquid (4) and is thereby separated from the working medium; and discharging the dried working medium (7). The invention further relates to a corresponding water separator (1) and to a water separator system (15).

The invention relates to a method of separating water from a gaseous working medium, and to a water separator and a water separator system for such a working medium, especially for use in compressor stations for natural gas or hydrogen, for example.

Compressor stations for natural gas or hydrogen, for example, are basically designed for operation with a dry working gas. If such a compressor station is supplied with a water-containing working gas, the reprocessing of these water-containing gas mixtures constitutes a particularly important operating step. The removal of the water fractions firstly serves to prevent unwanted condensation in downstream apparatuses and connecting pipelines. Secondly, an excessively high water content is problematic in the case of downstream utilization of combustion gases in internal combustion engines, since there can be corrosion damage. Therefore, drying systems are used.

Drying systems according to the prior art work, for example, with beds of porous material, for example silica gel. Such materials of high porosity absorb the water content from the working gas. The porous beds in prior art drier systems fundamentally require a very large volume. Regeneration of the bed can be undertaken by means of flow of dry unsaturated natural gas through the bed or by baking or exchanging the bed. Exchanging of the bed in the case of prior art drier systems necessitates opening of the container in order to be able to replace the bed completely. This lets out a great proportion of the working gas unutilized. With porous beds, it is only possible to a limited degree to free a working medium of particles, which necessitates a final filtration of the working medium. Moreover, porous beds break up easily under external load, for which even pressurizations at particularly high pressures are sufficient. As a result, the maximum operating pressure is limited. The maximum water absorption in the case of prior art bed materials is about 30% by weight of the intrinsic mass of the bed. The water absorption is thus highly limited. A further method uses triethylene glycol (TEG) for demoisturization of the working gas, but it is usually necessary to keep the process in multistage form in order to be able to achieve the desired purity.

Proceeding from this, it is an object of the present invention to at least partly overcome the disadvantages known from the prior art.

The features of the invention are apparent from the independent claims, for which advantageous configurations are indicated in the dependent claims. The features of the claims can be combined in any technically viable manner, for which it is also possible to refer to the elucidations from the description which follows and features from the figures comprising supplementary configurations of the invention.

The object of the invention is achieved by a method of separating water out of a gaseous working medium having at least the following steps:

a. holding a hygroscopic ionic liquid in a reaction chamber;

b. feeding a water-containing gaseous working medium into the reaction chamber and passing the working medium through the ionic liquid, wherein water is bound by the ionic liquid;

c. removing the dried working medium.

For this method, a reaction chamber holding an (especially highly) hygroscopic ionic liquid (which is especially miscible with water in any ratio, for example >=90%, meaning that the substance mixture has 10% by weight ionic liquid and 90% by weight of water) is maintained. In principle, a substance mixture formed from an ionic liquid used with preference may contain a water content of >0% by weight to <100% by weight. The reaction chamber is set up such that a gaseous working medium, preferably natural gas or hydrogen, can be introduced and can be conducted through the ionic liquid and can be removed again. Ionic liquids are salts (especially organic salts) having a lattice energy sufficiently low that these salts are liquid within a temperature range from preferably −25° C. up to their thermal decomposition point, which is preferably not less than 250° C., without the salt dissolving in a solvent, for example water. The ionic liquid may especially include methanesulfonate or ethanesulfonate (for example 50% by weight of each), for example 1-ethyl-3-methylimidazolium methanesulfonate (CAS No. 145022-45-3), tris(2-hydroxyethyl)methylammonium methylsulfate (CAS No. 29463-06-7, also referred to as ethanaminium, 2-hydroxy-N,N-bis(2-hydroxyethyl)-N-methyl-, methylsulfate), or 1-ethyl-3-methylimidazolium ethylsulfate (CAS No. 342573-75-5, also referred to as 1H-imidazolium, 1-ethyl-3-methyl-, ethylsulfate). In addition, the ionic liquid may be a mixture of the above mentioned constituents, especially of CAS No. 342573-75-5 and CAS No. 29463-06-7.

Other hygroscopic ionic liquids may likewise be used.

A particular advantage of such ionic liquids is that they have barely any measurable vapor pressure, comparable to steel, and they have very good dissolution properties, i.e, are highly hygroscopic. Ionic liquids are thus capable of binding water and correspondingly of separating it out of the moist gaseous working medium. By virtue of the low, barely measurable vapor pressure of the ionic liquids, the working medium is obtainable in (at least constantly) high purity after passing through the ionic liquid. In this context, more particularly, particles in the working medium are also separated out and retained by the ionic liquid. A particular advantage of this method is that the ionic liquid, being a liquid material, can easily be removed from the reaction chamber and can be cleaned or regenerated in a simple manner. Furthermore, it is a great advantage of this method that the cleaning of the working medium by means of the ionic liquid, in an advantageous working example of the invention, can be executed under elevated atmospheric pressure because the ionic liquid is incompressible (for technical purposes) and is mechanically insensitive compared to a bed. In this working example, an elevated pressure relative to the atmospheric pressure in an environment of the reaction chamber is thus preferably maintained in the reaction chamber at least during the separation of water. More preferably, the method is conducted in one stage. This is possible because of the low vapor pressure of the ionic liquid and the very high dissolution capacity of the ionic liquid.

The working medium is generally a gas or a biphasic fluid, especially having a significantly greater gas content of preferably greater than 90% by volume, although solid (contaminant) particles may also be present. A preferred working medium is natural gas or hydrogen.

In a further advantageous embodiment of the method, the method is executed as a continuous method, wherein a working medium inlet for introducing the water-containing working medium and a clean medium outlet for discharging the dried working medium are provided, wherein the working medium to be dried preferably rises or is conducted upward through the ionic liquid counter to the field of gravity. However, other modes of operation are also conceivable.

In this advantageous embodiment of the method, the gaseous working medium is passed preferably continuously through the ionic liquid, such that this cleaning or drying of the working medium can be incorporated into a continuous (or else quasi-continuous) process, and the working medium can be fed (quasi-)continuously, for example, to a compression (especially in a downstream compressor station).

More preferably, the working medium is supplied to the ionic liquid from beneath and rises upward in the ionic liquid counter to the (earth's) field of gravity because of its lower density compared to the ionic liquid and is discharged via the clean medium outlet above the liquid level of the ionic liquid. The clean medium refers here to the dried working medium which has possibly been freed of particles. As an alternative to a flow direction of the working medium in the vertical, however, it is also possible to guide the flow of the working medium in the horizontal.

In a further advantageous embodiment of the method, the ionic liquid is reprocessed by heating the reaction chamber and removing the water separated out in vaporous form via a water outlet, wherein a desired degree of drying is preferably achieved by heating the ionic liquid over a predetermined (for example empirically determined) heating time. Alternatively, it is possible to heat the laden ionic liquid until a desired degree of drying has been established. This can be determined by one of the following measures:
determining the mass of the ionic liquid;
determining the mass of water separated out;
determining the starting mass of the ionic liquid prior to the reprocessing and/or prior to the separation of water and during the reprocessing, and comparing the residual mass of the ionic liquid to the starting mass; or
determining the electrical conductivity value or resistance of the ionic liquid.

The reprocessing is also executable as a separate method without the previously elucidated steps for separating water out of a working medium.

In the aforementioned preferred embodiment, the reaction chamber is simultaneously utilized for reprocessing (also called regeneration) of the ionic liquid, in which case the conduction of the working medium is preferably stopped in order to create no (great) losses of working medium. The sufficiently laden cleaning medium, i.e. the ionic liquid, is heated in the reaction chamber and, as a result, the bound water is separated from the ionic liquid and separated out in vaporous form. For this purpose, a water outlet is preferably provided, preferably arranged above the ionic liquid, such that preferably essentially only vaporous water (as a result of the low vapor pressure of the ionic liquid) is removed.

In an alternative embodiment of the method, the ionic liquid is exchanged for reprocessing, wherein the ionic liquid is preferably exchanged continuously, wherein particles collected in the separation method are more preferably filtered out.

In one variant of the method, the ionic liquid, or preferably a portion of the ionic liquid, is exchanged for reprocessing (i.e, drawn off from the reaction chamber and fed back in regenerated form), wherein the working medium, for separation of water, can preferably still be conducted continuously through the (remaining) ionic liquid. In a preferred embodiment, as much clean ionic liquid is constantly fed in as ionic liquid to be cleaned is removed. Most preferably, the ionic liquid is exchanged continuously, such that the degree of loading of the ionic liquid can especially be kept essentially constant or within certain limits. Advantageously, it is possible here to continuously filter collected particles out of the ionic liquid, for example by means of a filter downstream of the reaction chamber (for example in the conduits and/or in the reprocessing apparatus).

In a further advantageous embodiment of the method, the distilled water obtained in the reprocessing is collected, wherein the ionic liquid is preferably freed of particles beforehand by means of one or more filters.

In these preferred embodiments of the method, the water obtained is provided to a further process, for example. Most preferably, the ionic liquid here is freed of particles beforehand by means of one or more filters, such that a high-purity water distillate is obtained. In embodiments of the invention that use only one vessel or one reaction chamber for the separation and regeneration, preference is given to accomplishing the collection of water by means of alternately opened clean medium outlet and water outlet. In the case that separation and reprocessing are spatially separated, continuous removal of water is possible.

In a further advantageous embodiment of the method, any dead space in the reaction chamber is reduced down to a desired degree prior to commencement of exchange of the ionic liquid by means of raising the liquid level, wherein a safety margin from the (upper) outlets present can be included (in order not to flood them, for example).

In this preferred embodiment, the dead space in the reaction chamber, i.e, the space not filled with an ionic liquid, is preferably reduced as far as permitted by process reliability in particular. As a result, the volume in which the working medium is not treated is kept small, such that the volume efficiency of this process is very high, especially compared to beds. Furthermore, prior to exchange and/or during exchange of the ionic liquid, the dead space is either kept as small as possible or reduced to be as small as possible, in order to prevent an (excessively) high proportion of working medium from being let out and hence lost in the cleaning process.

In a further advantageous embodiment of the method, the dried working medium to be removed is conducted through at least one coalescence filter in order to execute fine separation of water fractions before it is removed as clean medium and provided to a downstream process.

In a further advantageous embodiment of the method, an elevated atmospheric pressure is maintained in the reaction chamber at least during the water absorption.

Through use of elevated atmospheric pressure, it is firstly possible to process a greater molar amount of the working medium to be dried in the reaction chamber. Furthermore, the vapor pressure of the ionic liquid is reduced further and incorporation into an elevated pressure level of an upstream and/or downstream process is made considerably easier.

In a further aspect of the invention, a water separator is proposed for a gaseous working medium, comprising at least the following components:
a liquid-tight reaction chamber to accommodate a hygroscopic ionic liquid, wherein the reaction chamber is especially filled with the hygroscopic ionic liquid (which then constitutes a constituent of the water separator), and wherein the reaction chamber is especially designed to bear an elevated pressure relative to the ambient atmosphere of the reaction chamber;
a closable working medium inlet for introducing the gaseous and water-containing working medium to be dried into the reaction chamber, wherein the working medium inlet is especially arranged beneath the reaction chamber; and
a closable clean medium outlet for removing the dried working medium from the reaction chamber, wherein the clean medium outlet is especially arranged above the reaction chamber.

The water separator thus comprises a liquid-tight reaction chamber which is preferably additionally designed so as to be gas-tight. This reaction chamber preferably contains or can accommodate the (highly) hygroscopic ionic liquid, as already described at the outset.

More particularly, the working medium inlet and the clean medium outlet are arranged opposite one another along a longitudinal axis of the reaction chamber along which the reaction chamber extends or has a maximum extent, such that the working medium is treated over a maximum distance. Most preferably, the clean medium outlet, based on the (earth's) field of gravity, is arranged above the reaction chamber and the working medium inlet below the reaction chamber. In other words, the longitudinal axis of the reaction chamber preferably extends along the vertical. However, the reaction chamber can also be aligned along the horizontal, such that the longitudinal axis runs horizontally (and the working medium correspondingly flows from left to right or vice versa).

In the case of vertical alignment of the reaction chamber, the gaseous working medium, which generally has a lower density than the ionic liquid, can rise of its own accord counter to the field of gravity in the ionic liquid, i.e. without active supply of energy, wherein at least a majority of the water content of the working medium is bound by the hygroscopic ionic liquid. Because of the low vapor pressure of the ionic liquid already described above, an (essentially) highly pure, dried working medium thus separates from the ionic liquid in the clean medium outlet, and can now be supplied to a further process.

The reaction chamber is preferably designed to be pressure-rated, such that the method can also be conducted at a distinctly elevated pressure compared to the surrounding atmosphere.

The water separator is preferably set up for the performance of a method according to the above description.

In a further advantageous embodiment of the water separator, at least one water outlet is preferably additionally provided or arranged above the reaction chamber, wherein water that evaporates off can be removed via the water outlet in the course of reprocessing of the ionic liquid in the reaction chamber.

In addition, the reaction chamber may have a heating element which serves to boil off the water bound to the ionic liquid that has separated out. In this embodiment, it is thus possible to reprocess/regenerate the ionic liquid in the reaction chamber itself.

In a further advantageous embodiment of the water separator according to one of the above embodiments, at least one exchange outlet is additionally provided, preferably below the reaction chamber, and is set up and provided for supply and/or removal of ionic liquid to and/or from the reaction chamber.

Through the exchange outlet, the ionic liquid is especially removable from the reaction chamber, such that, for example, reprocessing of the ionic liquid can be undertaken outside the reaction chamber. Thus, supply and removal is executable in a particularly simple manner, for example by means of a liquid pump.

In a further advantageous embodiment of the water separator, at least one inlet and at least one outlet are provided, by means of which the ionic liquid is continuously exchangeable. In this case, the ionic liquid can thus be drawn off by the outlet and, at the same time, be fed—in regenerated form—into the reaction chamber via the inlet.

The loading of the ionic liquid can thus advantageously be regulated and continuous operation of the water separator is possible. The water separator can thus advantageously be incorporated into a continuous process structure.

In a further advantageous embodiment of the water separator, the clean medium outlet has at least one coalescence filter or is in flow connection with such a filter on the reaction chamber side. This coalescence filter is preferably designed to separate water fractions still present out of the dried working medium.

In a further aspect of the invention, a water separator system for drying a gaseous working medium is proposed, wherein the water separator system has at least one water separator of the invention (for example according to an embodiment described herein) and at least one separate reprocessing apparatus which is set up to reprocess (regenerate) the ionic liquid, such that it can be introduced back into the reaction chamber.

The reprocessing apparatus may include at least one particle filter for filtering particulate impurities out of the ionic liquid. In addition, the reprocessing apparatus preferably has at least one heating element for heating the ionic liquid or for evaporating water bound to the ionic liquid. In addition, the reprocessing unit preferably has at least one water outlet for removing the evaporated water.

The reprocessing apparatus is preferably flow-connected to the reaction chamber via at least one flow path, preferably via an inlet and an outlet of the reaction chamber, such that continuous reprocessing of the ionic liquid is possible. In this case, the ionic liquid is drawn off from the reaction chamber via the outlet, regenerated in the reprocessing apparatus and returned back to the reaction chamber via the inlet.

The separation of water out of the working medium in the reaction chamber can especially be conducted at pressures in the reaction chamber in the range from 1 bar (or 0 bara) to 551 bar (or 550 bara), especially in the range from 20 bar to 330 bar, especially in the range from 16 bar to 250 bar, and especially at temperatures in the reaction chamber in the range from +60° C. to +250° C., especially +60° C. to +160° C., especially +60° C. to +150′C.

When the working medium is natural gas or the working medium includes natural gas, the separation of water out of the working medium preferably takes place at a temperature in the reaction chamber in the range from +60° C. to +150° C. and a pressure in the reaction chamber in the range from 20 bar to 330 bar.

When the working medium is hydrogen or the working medium includes hydrogen, the separation of water out of the working medium preferably takes place at a temperature in the reaction chamber in the range from +60° C. to +160° C. and a pressure in the reaction chamber in the range from 16 bar to 250 bar.

The invention described above is elucidated in detail hereinafter against the technical background in question with reference to the accompanying drawings, which show preferred embodiments. The figures show.

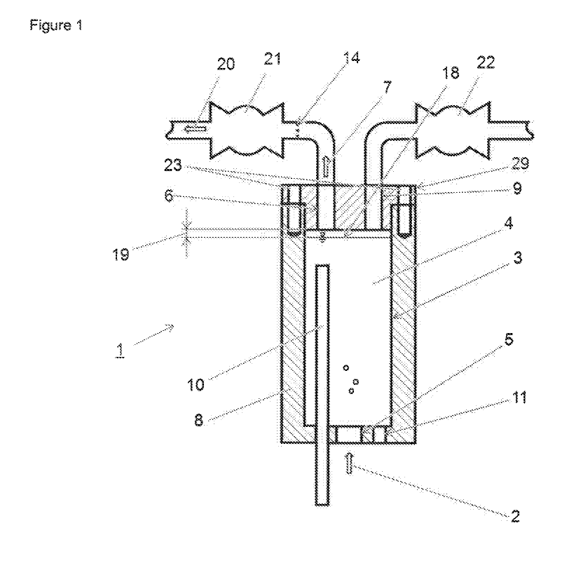

FIG. 1: a water separator with a heating element; and

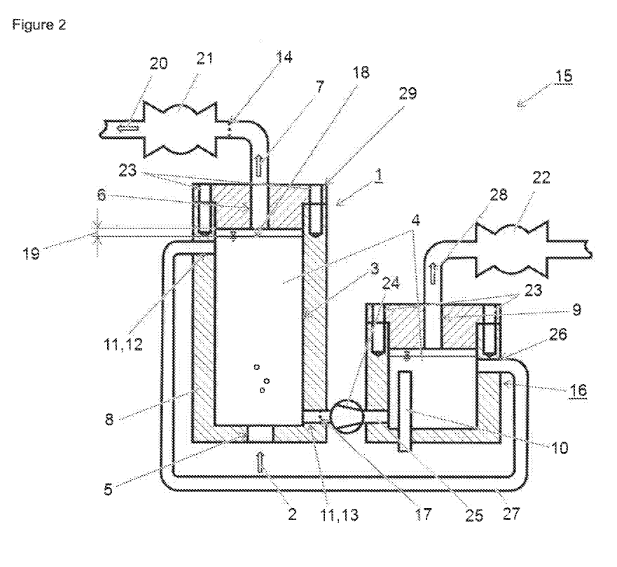

FIG. 2: a water separator system with a separate reprocessing apparatus.

FIG. 1 shows a water separator 1 in which a reaction chamber 3 filled with an ionic liquid 4 up to a liquid level 18 is provided. A heating element 10 which projects into the reaction chamber 3 can be used to heat the ionic liquid 4. At the lower end of the reaction chamber 3, a working medium inlet 5 is provided, via which (water-containing) gaseous working medium 2 to be dried, preferably natural gas or hydrogen, can be introduced into the reaction chamber 3.

Additionally provided is a clean medium outlet 6 at the top end of the reaction chamber 3, which in this example is arranged in a lid 29 (see below) of the reaction chamber 3. A dried working medium 7 can be removed via the clean medium outlet 6.

The reaction chamber 3 in operation preferably extends along a vertical longitudinal axis or cylinder axis, with the working medium inlet 5 and the clean medium outlet 6 opposite one another along the longitudinal axis. The reaction chamber 3 may have a cylindrical chamber wall 8 that extends along the longitudinal axis and may be closed at the bottom by a base joined to the wall (apart from any inlets and outlets). At the upper end, the reaction chamber 3 is preferably closed by the lid or cylinder head 29, which can be screw-connected to the wall 8 via screws, of which only the screwholes 23 are shown here in schematic form.

Additionally provided above the reaction chamber 3 is a water outlet 6 via which water vapor can be removed in the course of reprocessing of the ionic liquid 4, for example by means of heating of the ionic liquid 4 by means of the heating element 10. The clean medium outlet 6 and the water outlet 9 (see below) are preferably formed in the lid 29.

In addition, an exchange outlet 11 is arranged beneath the reaction chamber 3, via which the ionic liquid 4 can be supplied to and removed from the reaction chamber 3. In this example, the clean medium outlet 6 can be closed by means of the clean medium shutoff valve 21, for example when the ionic liquid 4 is being reprocessed (by means of heating). In addition, the water outlet 9 can also be closed by means of a water shutoff valve 22, for example during the separation phase when the water-containing working medium 2 is being dried. In addition, in this preferred example, a coalescence filter 14 is flow-connected to the clean medium outlet 6 downstream of the reaction chamber 3, and is set up and provided for fine separation of the residual water content in the dried working medium 7. Thereafter, a clean medium 20 can be fed to a downstream process or to a storage means. The dead volume of the reaction chamber 3 is very small here and is especially limited merely to a safety margin 19 between the liquid level 18 and the lid 29. Thus, the dead volume in the reaction chamber 3 is much smaller than is the case, for example, with beds. The water separator 1 shown here is particularly compact and allows continuous performance of the separation of water from the gaseous working medium.

FIG. 2 provides a water separator system 15 with a water separator 1 and a separate reprocessing apparatus 16, wherein the water separator 1 is of similar construction to that shown in FIG. 1 and, here too, the chamber wall 8 is preferably designed for elevated pressure relative to the surrounding atmosphere. In this case, by contrast with FIG. 1, an inlet 12 and an outlet 13 are provided in the reaction chamber 3, and these thus form two exchange connections 11. The inlet 12 allows the supply of ionic liquid 4 which can be fed in in reprocessed form from the reprocessing apparatus 16. The outlet 13 connects the water separator 1 and the reprocessing apparatus 16, such that the ionic liquid 4 can be fed, here for example by means of a pump 24, to the reprocessing in the reprocessing apparatus 16. In this case, more particularly, a particle filter 17 is provided downstream of the reaction chamber 3 or in the outlet 13, by means of which particles introduced by the water-containing working medium 2 are separable from the ionic liquid 4. In the reprocessing apparatus 16, a heating element 10 is provided, by means of which the ionic liquid 4 which can be introduced via the reprocessing inlet 25 can be heated, such that water is released in vaporous form and can be removed as water vapor 28 via a water outlet 9 of the reprocessing unit 16. The dried ionic liquid is then removed via the reprocessing outlet 26 and is fed in turn via a recycle conduit 27 and the inlet 12 to the reaction chamber 3. By contrast with FIG. 1, it is thus possible to execute a continuous separation and regeneration method, such that this water separator system 15 is especially suitable for continuous processes in which no interruption to the water separation is normally envisaged.

This method is as far as possible conducted such that a water-containing gaseous working medium 2 is fed to the reaction chamber 3 from beneath by the working medium inlet 5 and rises upward as a result of the lower density or a pressure maintained in the reaction chamber 3 and releases its water content to the ionic liquid as it does so. Subsequently, the dried gaseous working medium ascends out of the ionic liquid 4 and is removed via the clean medium outlet 6. The ionic liquid 4, by contrast, is continuously or alternately removed and heated, and hence the water content is separated out in vaporous form and the regenerated ionic liquid is fed back to the reaction chamber 3, preferably in cooled form.

In a first example of the invention, water is separated out of a natural gas-containing working medium 2 using one of the above-described ionic liquids, wherein the separation of water out of the working medium is conducted at a temperature in the reaction chamber in the range from +60° C. to +150° C. and a pressure in the reaction chamber 3 of 20 bar to 330 bar.

In a second example of the invention, water is separated out of a hydrogen-containing working medium 2 using one of the above-described ionic liquids, wherein the separation of water out of the working medium is conducted at a temperature in the reaction chamber 3 in the range from +60° C. to +160° C. and a pressure in the reaction chamber of 16 bar to 250 bar.

With the water separator proposed here and the corresponding method, it is possible with a reduced construction volume and with superatmospheric pressure to dry a water-containing working medium, optionally in a continuous manner.

List of reference numerals

| | |
|---|---|
| 1 | Water separator |
| 2 | Water-containing working medium |
| 3 | Reaction chamber |
| 4 | Ionic liquid |
| 5 | Working medium inlet |
| 6 | Clean medium outlet |
| 7 | Dried working medium |
| 8 | Chamber wall |
| 9 | Water outlet |
| 10 | Heating element |
| 11 | Exchange connection |
| 12 | Inlet |
| 13 | Outlet |
| 14 | Coalescence filter |
| 15 | Water separator system |
| 16 | Reprocessing apparatus |
| 17 | Particle filter |
| 18 | Liquid level |
| 19 | Safety margin |
| 20 | Clean medium |
| 21 | Clean medium shutoff valve |
| 22 | Water shutoff valve |
| 23 | Screwholes |
| 24 | Pump |
| 25 | Reprocessing inlet |
| 26 | Reprocessing outlet |
| 27 | Recycle conduit |
| 28 | Water vapor |
| 29 | Lid (screw-connectable cylinder head) |

1. A method of separating water out of a gaseous working medium, characterized in that at least the following steps are conducted:
a) holding a hygroscopic ionic liquid in a reaction chamber;
b) feeding the water-containing working medium into the reaction chamber and passing the working medium through the ionic liquid, wherein water is bound by the ionic liquid and hence separated out of the working medium;
c) removing the dried working medium.

2. The method as claimed in claim 1, characterized in that the method is executed as a continuous method, wherein a working medium inlet for introducing the water-containing working medium into the reaction chamber and a clean medium outlet for discharging the dried working medium from the reaction chamber are provided in the reaction chamber, wherein the working medium to be dried is conducted upward through the ionic liquid counter to the field of gravity in the reaction chamber.

3. The method as claimed in claim 1, characterized in that the ionic liquid is reprocessed by heating the reaction chamber and removing the water separated out in vaporous form via a water outlet, wherein the ionic liquid is heated until the water content has been reduced to a predefined value, wherein the ionic liquid is heated for this purpose over an empirically determined heating time or the water content is determined by means of at least one of the following measures:
determining the fill level of the ionic liquid;
determining the mass of the ionic liquid;
determining the mass of water separated out; and
determining the electrical conductivity value of the ionic liquid.

4. The method as claimed in claim 1, characterized in that the ionic liquid is exchanged for reprocessing, wherein water-laden ionic liquid is especially drawn off from the reaction chamber and reprocessed ionic liquid is fed into the reaction chamber, and wherein the ionic liquid is exchanged continuously, wherein particles collected in the separation method are more filtered out at the same time.

5. The method as claimed in claim 3, characterized in that the distilled water obtained in the reprocessing is collected, wherein the ionic liquid is freed of particles beforehand by means of at least one filter.

6. The method as claimed in claim 1, characterized in that any dead space in the reaction chamber is reduced down to a desired level by means of raising the liquid level of the ionic liquid, down to a predefined safety margin from the clean medium outlet and/or the water outlet.

7. The method as claimed in claim 1, characterized in that the dried working medium to be removed is conducted through at least one coalescence filter in order to execute fine separation of water fractions before it is removed as clean medium and provided to a downstream process.

8. The method as claimed in claim 1, characterized in that, in step b), the separation of water out of the working medium in the reaction chamber is conducted at pressures in the reaction chamber in the range from 1 bar to 551 bar and/or at temperatures in the reaction chamber in the range from +60° C. to +250° C.

9. A water separator for a gaseous working medium to be dried, characterized in that the water separator comprises at least the following components:
a liquid-tight reaction chamber to accommodate a hygroscopic ionic liquid, wherein the reaction chamber is filled with the hygroscopic ionic liquid, and wherein the reaction chamber is designed to bear an elevated pressure relative to the ambient atmosphere of the reaction chamber;
a closable working medium inlet for introducing the gaseous and water-containing working medium to be dried into the reaction chamber, wherein the working medium inlet is arranged beneath the reaction chamber; and
a closable clean medium outlet for removing the dried working medium from the reaction chamber, wherein the clean medium outlet is arranged above the reaction chamber.

10. The water separator as claimed in claim 9, characterized in that at least one preferably closable water outlet is additionally arranged above the reaction chamber, wherein evaporating water can be removed from the reaction chamber via the water outlet, in the course of reprocessing of the ionic liquid in the reaction chamber, and wherein the reaction chamber has at least one heating element for boiling off the water.

11. The water separator as claimed in claim 9, characterized in that at least one exchange outlet is additionally provided, beneath the reaction chamber, for supply of ionic liquid into the reaction chamber and for removal of ionic liquid from the reaction chamber.

12. The water separator as claimed in claim 9, characterized in that at least one inlet and at least one separate outlet are provided in the reaction chamber for the ionic liquid, such that the ionic liquid in the reaction chamber is continuously exchangeable.

13. The water separator as claimed in claim 9, characterized in that the clean medium outlet is put into flow connection with a coalescence filter set up for fine separation of water fractions from the dried working medium.

14. A water separator system for drying a working medium, characterized in that the water separator system has at least one water separator comprising a liquid-tight reaction chamber to accommodate a hygroscopic ionic liquid, wherein the reaction chamber is filled with the hygroscopic ionic liquid, and wherein the reaction chamber is designed to bear an elevated pressure relative to the ambient atmosphere of the reaction chamber; a closable working medium inlet for introducing the gaseous and water-containing working medium to be dried into the reaction chamber, wherein the working medium inlet is arranged beneath the reaction chamber; and a closable clean medium outlet for removing the dried working medium from the reaction chamber, wherein the clean medium outlet is arranged above the reaction chamber and at least one reprocessing apparatus for reprocessing the ionic liquid for the reaction chamber, wherein the reprocessing apparatus has at least one particulate filter for filtering out particulate impurities, and has at least one heating element for evaporating water that has separated out and at least one water outlet for removing evaporated water.
